(19) United States
(12) Patent Application Publication
(10) Pub. No.: US 2011/0134758 A1
(43) Pub. Date: Jun. 9, 2011

(54) INFORMATION PROCESSING APPARATUS, CONTROL METHOD THEREOF AND COMPUTER PROGRAM

(75) Inventor: Minoru Fujisawa, Machida-shi (JP)

(73) Assignee: CANON KABUSHIKI KAISHA, Tokyo (JP)

(21) Appl. No.: 12/812,006

(22) PCT Filed: May 13, 2010
(86) PCT No.: PCT/JP2010/058492

§ 371 Date: Jul. 7, 2010

(30) Foreign Application Priority Data
Jun. 15, 2009 (JP) 2009-142710

(51) Int. Cl. H04L 12/26

(52) U.S. Cl. 370/241

(57) ABSTRACT

An information processing apparatus readily captures packet data effective in analyzing failures that occur in a network. To accomplish this, the information processing apparatus evaluates the necessity for changing a storage condition defined in filter setting data created by a developer or the like, displays a plurality of appropriate candidates if there is an inappropriate rule, and causes a service person to select from the appropriate candidates. Further, the information processing apparatus generates a filter based on an input from the service person and appropriate filter setting data, and captures packet data using the generated filter.

### TECHNICAL FIELD

The present invention relates to an information processing apparatus that communicates with external apparatus, and to a control method thereof.

### BACKGROUND ART

Heretofore, techniques for capturing packets flowing through a network communication path in the case where a failure occurs in a network communication device, and investigating the cause of the failure are known. One typical method involves connecting a device dedicated to performing packet capture to a line concentrator such as a hub, and specifying the failure by capturing packets flowing over a LAN (Local Area Network) and analyzing the data content of the packets. Failures may also be specified by saving captured packets to memory or the like as log data, and analyzing the saved log data. With the function of saving log data such as network packets, it is most important to correctly save necessary data of the correct size in the correct order at a timing approximating the occurrence of the failure or at a timing desired for acquiring log data.

Generally, in a marketplace, if there is trouble with a device, the vendor of the device is contacted by the user of the marketplace and responds to the marketplace failure. At this time, a service person from the vendor takes all network packets captured for each device back to the vendor with the user's consent, and the cause of the failure is investigated on the development side by analyzing the network packets. Sometimes the network packets brought back from the marketplace have been constantly captured from before the failure occurred, while at other times a service person recreates the failure after being sent to the location of the failure and interviewing the user, and captures and brings back network packets flowing at the time. A problem that arises when packets are captured with such methods is that a large number of packets that are not directly related to the failure are also captured and saved at the same time; a result of network packets having been captured over a long period of time before the failure occurs. While depending also on the marketplace-specific network environment, a huge number of packets flow over a network encompassing a device targeted for investigation. Capturing all of these packets requires a storage area of several hundred bytes to several gigabytes in several tens of minutes. Continually capturing such large numbers of packets uses limited device resources for long periods of time, and also leads to a drop in device performance. Further, when many of the captured packets are unrelated to the marketplace failure, the failure analysis time on the development side that receives the data from the service person is unnecessarily increased, hindering a quick response to the marketplace failure. Consequently, packets effective against failures that occur need to be efficiently captured in the network environment of a marketplace. A measure typically carried out in response to such problems involves capturing packets using filters.

A packet filter is a method used in network packet capture for capturing only those portions necessary in subsequent data analysis and disregarding all other portions. Data targeted for capture is typically differentiated from other data by specific network protocol names or protocol versions, or by the IP addresses or port numbers of data transmission sources/destinations. The manager of a device targeted for investigation or the service person sent to the location of the failure ends up configuring the settings of data to be captured and data to be disregarded. In order to efficiently capture packets effective against failures that occur in the network environment of a marketplace, expertise on what filter definitions to set is necessary, making it difficult for a device manager or a service person with no connection to the developer to configure filter settings. Consequently, the present situation is that the designer creates filter settings for each individual failure, and provides the filter settings to the service person as a file. The service person performs network packet capture by loading this file to the device targeted for investigation at the location of the failure and applying the filter settings. However, there is a problem with this method in that if there are errors or conflicts in the filter settings, effective data cannot be captured since the filter settings that should originally have been applied are not applied. In view of this, Japanese Patent Laid-Open No. 2003-333084 proposes a method for permitting or prohibiting passage of network packets as a firewall, although this is not a filtering method aimed at capturing or disregarding network packets. With this method, filter settings are checked in the order in which set packet filters were registered, information relating to conflicting rules is output at the point in time at which the conflicting rules are detected, and the service person inputs which rules to apply. Conflicts between settings in the filter settings can thereby be detected, and the filter process that should originally have been performed can be correctly performed.

However, with the above conventional technology, only conflicts between settings in the filter settings are resolved, while the following problems remain. For example, in the case where filter settings created by the developer are not effective in the process of capturing effective network packets, the service person may possibly only bring back packets that are irrelevant to the investigation. In this case, the device developer will become aware of the need to recapture packets at the point in time at which packet data is verified, and the response to the marketplace failure will be delayed. In other words, since it remains unclear whether investigation packets effective in responding to a marketplace failure were properly captured until the captured packets are actually verified, the service person who performs the packet capture operation has no way of perceiving whether effective investigation packets where successfully captured. On the other hand, for a service person with little network expertise to configure filter settings for market failures that arise in dynamic marketplace-specific network environments is not easy given that it takes time and leads to filter setting errors. Consequently, with failure response according to conventional technology, time and cost are expended, and the trust of the client is lost.

### SUMMARY OF INVENTION

The present invention enables realization of an information processing apparatus for readily capturing packet data effective for analyzing failures that occur in a network.

One aspect of the present invention provides an information processing apparatus connected to an external apparatus via a network, comprising: reception means for receiving filter setting data in which a storage condition is defined, the storage condition being a condition for storing necessary packet data as log data from packet data flowing through the network; determination means for determining whether or not the storage condition defined in the received filter setting data needs to be changed; display control means for displaying, on a display unit, a display screen including a plurality of change candidates relating to the storage condition, when it is determined that the storage condition needs to be changed; change means for changing the storage condition defined in the filter setting data in accordance with information input by an operator via the display screen; generation means for generating a filter in accordance with the filter setting data; and capture means for capturing the packet data using the generated filter.

Another aspect of the present invention provides a control method of an information processing apparatus connected to an external apparatus via a network, comprising: receiving, in reception means, filter setting data in which a storage condition is defined, the storage condition being a condition for storing necessary packet data as log data from packet data flowing through the network; determining, in determination means, whether or not the storage condition defined in the received filter setting data needs to be changed; displaying, in display control means, a display screen including a plurality of change candidates relating to the storage condition on a display unit, when it is determined that the storage condition needs to be changed; changing, in change means, the storage condition defined in the filter setting data in accordance with information input by an operator via the display screen; generating, in generation means, a filter in accordance with the filter setting data; and capturing, in capture means, the packet data using the generated filter.

Still another aspect of the present invention provides a computer-readable storage medium storing a computer program for causing a computer to execute the control method of an information processing apparatus.

Further features of the present invention will be apparent from the following description of exemplary embodiments with reference to the attached drawings.

### BRIEF DESCRIPTION OF DRAWINGS

FIG. 1 shows an overall configuration of an information processing system 100 according to a First Embodiment.

FIG. 2 is a block diagram showing a control configuration of an MFP 101 according to the First Embodiment.

FIG. 3 is a block diagram showing a software configuration of the MFP 101 according to the First Embodiment.

FIG. 4 illustrates control of a packet capture application 305 according to the First Embodiment.

FIG. 5 is a flowchart showing a processing procedure for generating a filter definition according to the First Embodiment.

FIG. 6 is a flowchart showing a detailed processing procedure of S604 according to the First Embodiment.

FIG. 7 is a flowchart showing a detailed processing procedure of S605 according to the First Embodiment.

FIG. 8 is a flowchart showing a detailed processing procedure subsequent to S811 according to the First Embodiment.

FIG. 9 is a flowchart showing a detailed processing procedure of S606 according to the First Embodiment.

FIG. 10 shows an example of a user interface displaying generated candidates according to the First Embodiment.

FIG. 11 illustrates a method of capturing packet data according to a Second Embodiment.

### DESCRIPTION OF EMBODIMENTS

Embodiments of the present invention will now be described in detail with reference to the drawings. It should be noted that the relative arrangement of the components, the numerical expressions and the numerical values set forth in these embodiments do not limit the scope of the present invention unless it is specifically stated otherwise.

### First Embodiment

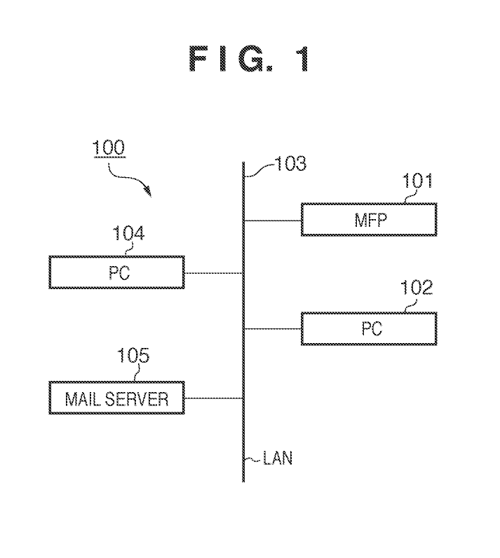

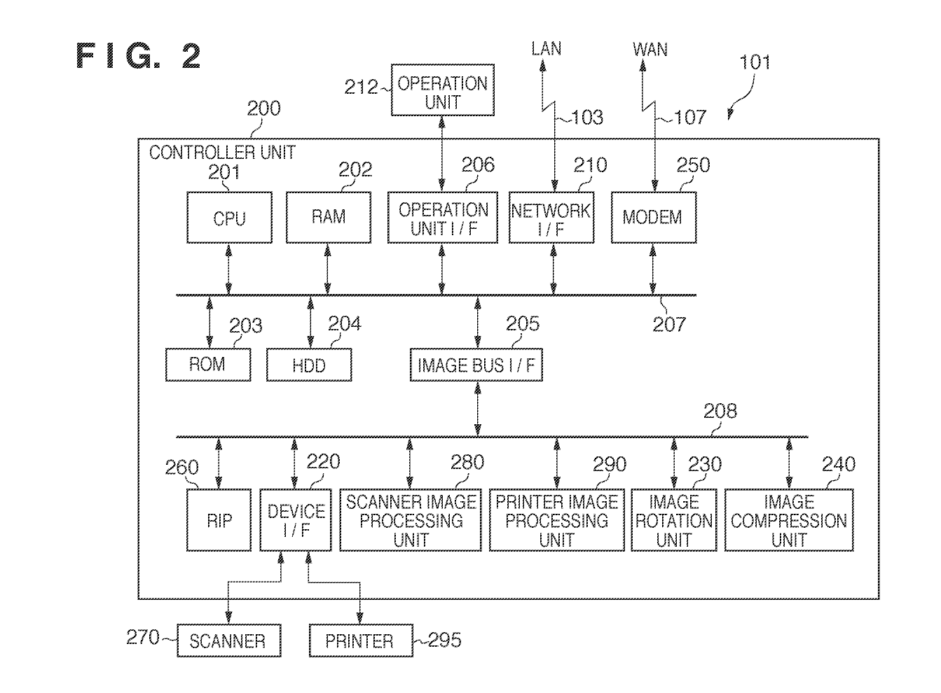

Firstly, an information processing system according to the present embodiment will be described with reference to FIG. 1. With an information processing system 100, a network is constructed by a LAN 103 that employs an Ethernet (registered trademark). Also, the information processing system 100 has a MFP (Multifunction Peripheral) 101 serving as an information processing apparatus, PCs 102 and 104, and a mail server 105. The MFP 101 transmits and receives packet data with respect to the PCs 102 and 104 and the mail server 105, which are external apparatus, via the LAN 103. The hardware of the MFP 101 will be discussed in detail below using FIG. 2.

The PC 102 and the PC 104 are typical personal computers. The PCs 102 and 104 are provided with a CPU, a RAM, a ROM, an HDD, a CD-ROM drive, an NIC (Network Interface Card), and a USB host interface. Also, the PCs 102 and 104 are provided with a bus for controlling these apparatus and peripheral apparatus that will be discussed below. Peripheral devices that can be connected to the PCs 102 and 104 include a mouse, a CRT display and a keyboard. The main functions of software installed on the PC 102 include an OS and office software such as a word processor and spreadsheet software. The OS is provided with a port monitor for transmitting print data to a printer or the MFP 101 via the network as one of those functions. Also, a mailer for performing transmission/reception of emails that involves transmitting emails to the mail server 105 and receiving emails from the mail server 105 is installed.

The mail server 105 is an email server that controls transmission/reception of emails using SMTP (Simple Mail Transfer Protocol) or POP3 (Post Office Protocol). It is assumed that email accounts for the MFP 101 and the PCs 102 and 104 are set in the mail server 105, and that settings for respective nodes to transmit emails via the mail server 105 have been configured.

Next, the control configuration of the MFP 101 will be described with reference to FIG. 2. As shown in FIG. 2, a scanner 270 serving as an image input device and a printer 295 serving as image output device are connected to a controller unit 200. The controller unit 200 performs control for realizing a copy function of printing out image data read by the scanner 270 using the printer 295. Also, the controller unit 200 performs control for inputting and outputting image information and device information by being connected to the LAN 103.

The controller unit 200 is provided with a CPU 201. The CPU 201 performs various types of processing by launching the operating system (OS) using a boot program stored in the ROM 203, and executing application programs stored in an HDD 204 on this OS. A RAM 202 is used as a work area of the CPU 201. The RAM 202 provides an image memory area for temporarily storing image data, in addition to the work area. The HDD 204 stores image data, in addition to the above application programs.

An operation unit I/F 206, a network I/F 210, a modem 250 and an image bus I/F 205 are connected to the CPU 201 via a system bus 207. The operation unit I/F 206 is an interface with an operation unit 212 having a touch panel, and outputs image data for displaying on the operation unit 212 to the operation unit 212. Also, the operation unit I/F 206 delivers information input on the operation unit 212 by a user to the CPU 201. The network I/F 210 is connected to the LAN 103, and performs input/output of information with apparatus on the LAN 103 via the LAN 103. The modem 250 is connected to a public line (not shown), and performs input/output of information. The image bus I/F 205 is a bus bridge for connecting the system bus 207 and an image bus 208 that performs high-speed transfer of image data, and converting the data structure. The image bus 208 is constituted by a PCI bus or an IEEE 1394 bus.

A raster image processor (hereinafter, RIP) 260, a device I/F 220, a scanner image processing unit 280, a printer image processing unit 290, an image rotation unit 230, and an image compression unit 240 are provided on the image bus 208. The RIP 260 is a processor that converts PDL code to a bitmap image. The scanner 270 and the printer 295 are connected to the device I/F 220, and the device I/F 220 performs synchronous/asynchronous conversion of image data. The scanner image processing unit 280 corrects, modifies and edits input image data. The printer image processing unit 290 performs printer correction, resolution conversion and the like on print output image data. The image rotation unit 230 rotates image data. The image compression unit 240 compresses multivalued image data to JPEG data and binary image data to JBIG, MMR, MH data or the like, as well as performing decompression thereof.

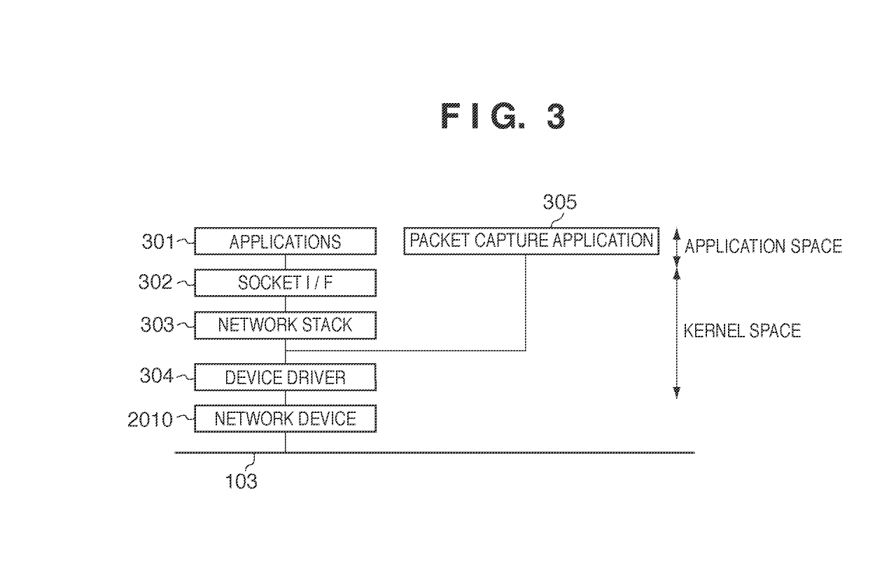

Next, the software configuration of the MFP 101 will be described with reference to FIG. 3. The MFP 101 is constituted by a general-purpose OS (Operating System) such as Linux. Applications 301 are a set of network applications that operate on the MFP 101. A socket I/F 302 is a socket I/F program provided by the OS. In the case where a network application included in the applications 301 performs communication, processing involving transmission/reception of data is enabled by calling the socket I/F 302. While not always necessary when a network application performs communication, the socket I/F 302 is able to reduce the man-hours of application development, since generic program commands and processing flows can be used irrespective of the type of OS. Thus, network applications typically perform transmission/reception of data by calling the socket I/F 302.

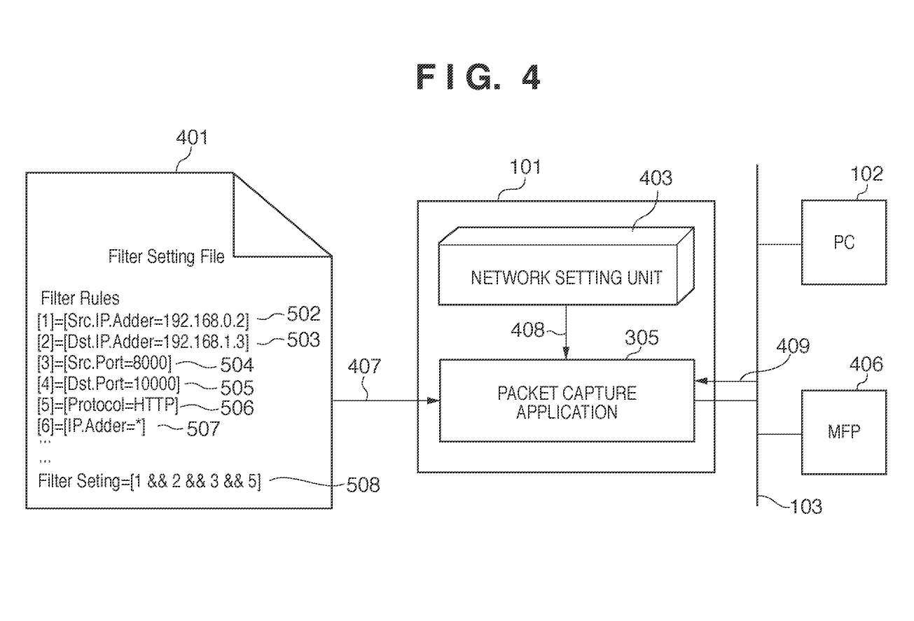

A network stack 303 is a group of protocol stacks. A network device driver 304 is the device driver of the network I/F 210. A packet capture application 305 is an application that captures network packets transmitted and received by the network I/F 210 and performs log output. The packet capture application 305 captures all packets that the network I/F 210 receives and all packets that the network I/F 210 transmits, by performing data capture from the network device driver 304. The processing content of the packet capture application 305 and the configuration of hardware used will be discussed in detail below using FIG. 4. The applications 301 and the packet capture application 305 operate in application space, and the socket I/F 302, the network stack 303 and the network device driver 304 operate in kernel space. Also, the applications may be realized by software, hardware or a combination thereof.

Next, control of the packet capture application 305 will be described with reference to FIG. 4. FIG. 4 shows a flow in which the packet capture application 305 of the MFP 101 acquires and loads data associated with filter settings. Reference numeral 401 denotes filter setting data. Generally, the device developer creates filter setting data 401 from information (IP address, port number, protocol name, etc.) associated with an investigation, in the case where the status of the device targeted for investigation is acquired from the service person (operator) performing the marketplace investigation, and there is judged to possibly be a network failure.

The MFP 101 holds a MAC address or an IP address as a network setting of the MFP 101 in order to operate on the LAN 103 to which the MFP 101 is connected. Also, the MFP 101 has a function of blocking access from specific MAC addresses or IP addresses from a security viewpoint, and holds these specific MAC addresses or IP addresses in a network setting unit 403 together with content relating thereto. Further, the MFP 101 holds various network protocols in accordance with the functions of the MFP 101. The network protocols have specific network port numbers set in order to perform communication using the individual network protocols, and the MFP 101 also holds these port numbers in the network setting unit 403.

The packet capture application 305 captures network packets flowing over the LAN 103, and saves the captured packets to a nonvolatile memory such as a HDD. However, capturing and saving all packets flowing over the LAN 103 leads to wasteful use of limited storage area, given that a large number of packets that are irrelevant to the investigation and analysis will be included. For example, reference numeral 406 is an MFP that is connected to the LAN 103, the same as the MFP 101. Network packets associated with the PC 102, the MFP 406 and the like flow over the LAN 103, and when packets are captured without filter settings, the packet capture application 305 of the MFP 101 ends up also capturing and saving network packets that are associated with the PC 102, the MFP 406 and the like but not with the MFP 101. In order to avoid this, the packet capture application 305 generates filter definitions based on external filter-related information, filters capture data captured in accordance with these definitions, and saves only necessary data.

An arrow 407 indicates the process of loading (reading) filter setting data 401 to the packet capture application 305. Generally, filter setting data 401 is created by the device developer, and loaded by the service person who handles responses in the marketplace. Methods of loading filter setting data 401 include directly transferring filter setting data to the MFP 101 using a nonvolatile memory such as a memory card, or transferring filter setting data to the MFP 101 with various types of network protocol using a network.

An arrow 408 indicates the process of the packet capture application 305 acquiring information held in the network setting unit 403. An arrow 409 indicates the process of the packet capture application 305 capturing packet data flowing over the LAN to which the MFP 101 is connected. The packet capture application 305 generates packet filter definitions using the three types of data acquired as a result of the processing indicated by arrows 407 to 409. Here, a packet filter definition is data that is changed as necessary after determining whether or not loaded filter setting data 401 needs to be changed. The method of using the three types of data will be discussed below.

Next, the filter setting data 401 will be described in detail. IP addresses, MAC addresses, port numbers, network protocol names and the like indicating the transmission source and transmission destination of packet data are described in the filter setting data 401, as storage conditions necessary in order for the packet capture application 305 to filter packets. A filter definitional equation indicating how to generate a filter using the above information is also described in the filter setting data 401.

Reference numerals 502 to 507 denote filter rule data (storage conditions). The filter rule data 502 indicates the transmission source IP address of network packets. The filter rule data 503 indicates the transmission destination IP address of network packets. The filter rule data 504 indicates the transmission source port number of network packets. The filter rule data 505 indicates the transmission destination IP address of network packets. The filter rule data 506 indicates a network protocol name. The filter rule data 507 indicates all of the IP addresses of network packets. Reference numeral 508 denotes a filter definitional equation for performing filtering using the above filter rule data. The filter definitional equation 508 indicates to filter and save only network packets communicated using an HTTP protocol with a transmission source port number 8000 from a device with a transmission source IP address 192.168.0.2 to a device with a transmission destination IP address 192.168.1.3.

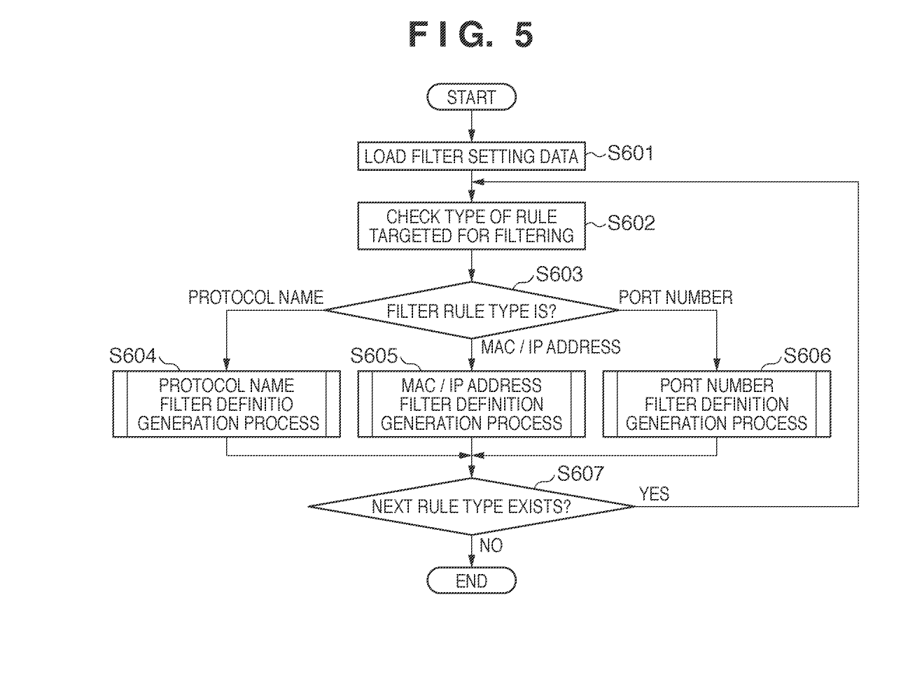

Next, the processing procedure of the packet capture application 305 generating a filter definition will be described with reference to FIG. 5. Note that overall control of the processing described hereinafter is performed by the packet capture application 305. Also, the numbers following the prefix “S” shown hereinafter indicate the numbers of steps in the flowcharts.

In S601, the packet capture application 305 loads filter setting data 401. In S602, the packet capture application 305 checks the filter definitional equation 508, and analyzes the type (protocol name, MAC/IP address, port number) of the individual filter rules (storage conditions) targeted for filtering. In S603, the packet capture application 305 determines the analyzed filter rule type. If the filter rule type is protocol name, the packet capture application 305 proceeds to S604, and generates a filter definition using protocol name. If the filter rule type is MAC/IP address, the packet capture application 305 proceeds to S605, and generates a filter definition using MAC/IP address. If the filter rule type is port number, the packet capture application 305 proceeds to S606, and generates a filter definition using port number. Once a filter definition has been generated, the processing proceeds to S607, and the packet capture application 305 again checks the filter definitional equation 508, and determines whether there is a subsequent filter rule targeted for filtering. If there is, the processing from S602 is executed on that rule. If there is not, the packet capture application 305 ends the processing. The packet capture application 305 then captures packet data flowing through the LAN 103 using the generated filter definition.

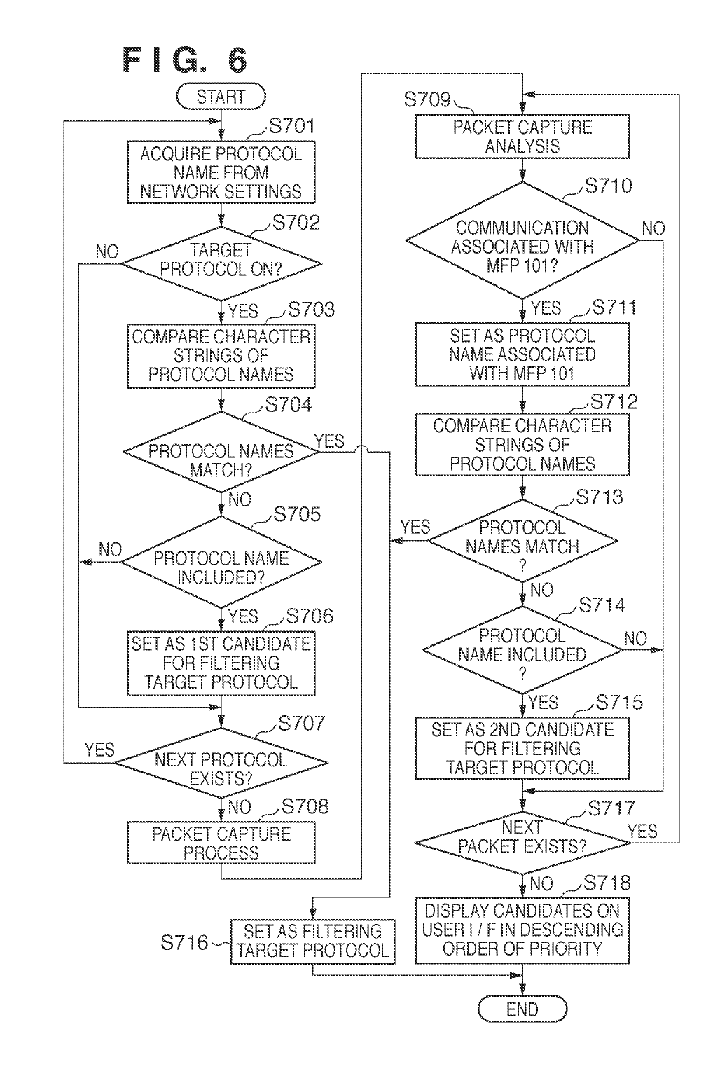

Next, the processing procedure of S604 shown in FIG. 5 will be described in detail with reference to FIG. 6. In S701, the packet capture application 305 acquires the name of a network protocol supported by the MFP 101 from the network setting unit 403. This acquired protocol name serves as a comparison target. In S702, the packet capture application 305 determines whether the protocol name acquired at S701 indicates a setting that is currently active on the MFP 101. If an inactive setting, the processing proceeds to S707.

On the other hand, if an active setting, the processing proceeds to S703, and the packet capture application 305 compares the character strings of the acquired protocol name and the protocol name described in the filter rule. The packet capture application 305 thereby verifies the necessity for changing the filter rule. Here, the protocol name acquired from the network setting unit 403 is a name uniquely defined in the MFP 101. In S704, the packet capture application 305 determines whether the protocol names match, in accordance with the comparison result. If the protocol names match, the processing proceeds to S716.

On the other hand, if the protocol names do not match, the packet capture application 305, in S705, determines whether there is a character string including the protocol name described in the filter rule. If there is not a character string including the protocol name, the processing proceeds to S707. On the other hand, if there is a character string including the protocol name, the packet capture application 305, in S706, sets that protocol as a first candidate for filtering target protocol.

Next, in S707, the packet capture application 305 determines whether there is a subsequent network protocol held in the network setting unit 403. If there is, the processing returns to S701. On the other hand, if there is not, the processing proceeds to S708, and the packet capture application 305 captures network packets flowing over the LAN 103 to which the MFP 101 is connected for a fixed period of time. Subsequently, in S709, the packet capture application 305 analyzes a captured packet and distinguishes the protocol type.

Next, in S710, the packet capture application 305 determines whether the analyzed packet is associated with communication with the MFP 101. This is determined using MAC addresses or IP addresses. At this time, transmission packets to a broadcast address or a multicast address are also included as communication associated with the MFP 101. If not communication associated with the MFP 101, the processing proceeds to S717.

On the other hand, if communication associated with the MFP 101, the processing proceeds to S711, and the packet capture application 305 acquires the same protocol name as the corresponding protocol from eigenvalues set in the MFP 101. Subsequently, in S712, the packet capture application 305 compares the character strings of the protocol name targeted for comparison acquired from the eigenvalues and the protocol name described in the filter rule. If, in S713, the protocol names match based on the comparison result, the processing proceeds to S716, and the packet capture application 305 sets that protocol as the filtering target protocol, and ends the processing.

On the other hand, if the protocol names do not match, the packet capture application 305, in S718, determines whether there is a character string that includes the protocol name described in the filter rule. If there is not a character string that includes the protocol name, the processing proceeds to S717. On the other hand, if there is a character string that includes the protocol name, the packet capture application 305, in S715, sets that protocol as a second candidate for filtering target protocol. With the candidates for filtering target protocol, since there is a greater possibility of filtering being performed with protocol candidates generated from the network setting unit 403, these protocol candidates are given higher priority, and protocol candidates generated as a result of capturing packets are given lower priority.

In S717, the packet capture application 305 determines whether there is a packet to be subsequently analyzed. If there is, the processing returns to S709. On the other hand, if there is not, the processing proceeds to S718, and the packet capture application 305, functioning as a display control unit, displays the names of generated protocol candidates on a user interface (display unit) in order of priority. In the case of a plurality of candidates having the same priority, the packet capture application 305 displays the candidates in the order in which they where generated.

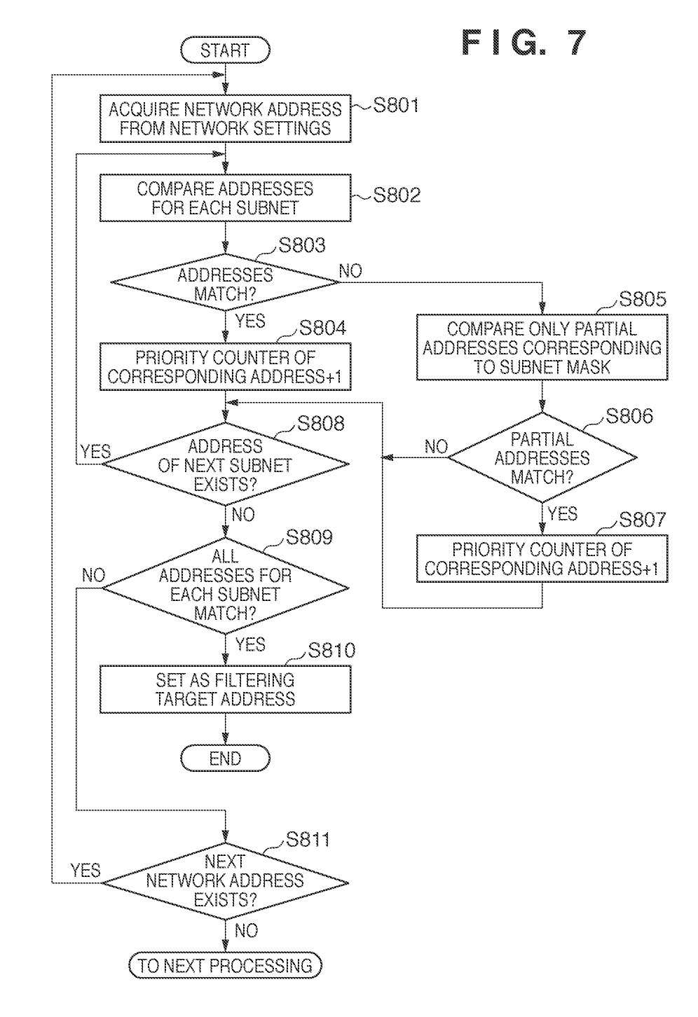

Next, the processing procedure of S605 in FIG. 5 will be described in detail with reference to FIG. 7. In S801, the packet capture application 305 acquires a network address set in the MFP 101 from the network setting unit 403. Here, a network address is an IP address, a MAC address or the like. The MFP 101 holds the network address of the MFP 101 in order to operate on the LAN to which the MFP 101 is connected, and the network address of the server that resolves host/domain names. Also, the MFP 101 has a function of blocking access from specific network addresses from a security viewpoint, and holds these specific network addresses in the network setting unit 403 together with information relating thereto. Further, the MFP 101 additionally holds network address information of communication destinations for each function supported by the MFP 101. The processing of S605 in FIG. 5 targets all of this network address information for comparison.

Next, in S802, the packet capture application 305 divides the acquired network address into each subnet. Taking an IP address as example, the address realm “A.B.C.D” is divided into each of the subnets A, B, C, and D. Similarly, the IP address described in the filter rule is also divided into each subnet. Taking an IP address described in a filter rule as an example, the address realm “a.b.c.d” is divided into each of the subnets a, b, c, and d. Further, in S802, the packet capture application 305 compares the values of the addresses of the individual subnets of the acquired network address and the network address described in the filter rule. Specifically, the packet capture application 305 compares the address A and the address a in a first comparison process, and compares the address B and the address b in a second comparison process. These comparison processes are performed for all of the subnets. The packet capture application 305 thereby verifies the necessity for changing the filter rule.

Next, in S803, the packet capture application 305 determines whether the individual addresses match. If the individual addresses match, the processing proceeds to S804, and the packet capture application 305 increments a priority counter for the corresponding network address. A network address that in the end has a priority counter with a large value is treated as a high priority address. On the other hand, if the individual addresses do not match, the processing proceeds to S805, and the packet capture application 305 firstly refers to a subnet mask of the MFP 101. Further, the packet capture application 305 determines whether the partial addresses assigned as subnets of the individual addresses match. For example, consider the case of comparing the address C and the address c in the case where the subnet mask of the MFP 101 is “0xFF.0xFF.0xFC.0x00” (hexadecimal notation). In this case, given that the subnet mask of the address portion is “0xFC”, the packet capture application 305 performs an AND operation on the subnet mask “0xFC” with respect to the respective addresses, if the address C and the address c do not match. As a result of the operation, the packet capture application 305 compares these values, using the respective obtained values as partial addresses.

In S806, the packet capture application 305 determines whether the partial addresses match. If the partial addresses match, the processing proceeds to S807, and the packet capture application 305 increments the priority counter for this network address, and proceeds to S808. On the other hand, if the partial addresses do not match, the processing proceeds to S808.

In S808, the packet capture application 305 determines whether there is an address of a subsequent subnet. If there is an address of a subsequent subnet, the processing returns to S802. On the other hand, if there is not an address of a subsequent subnet, the packet capture application 305 ends the process of comparing the network address described in the filter rule with single network addresses held by the MFP 101, and proceeds to S809.

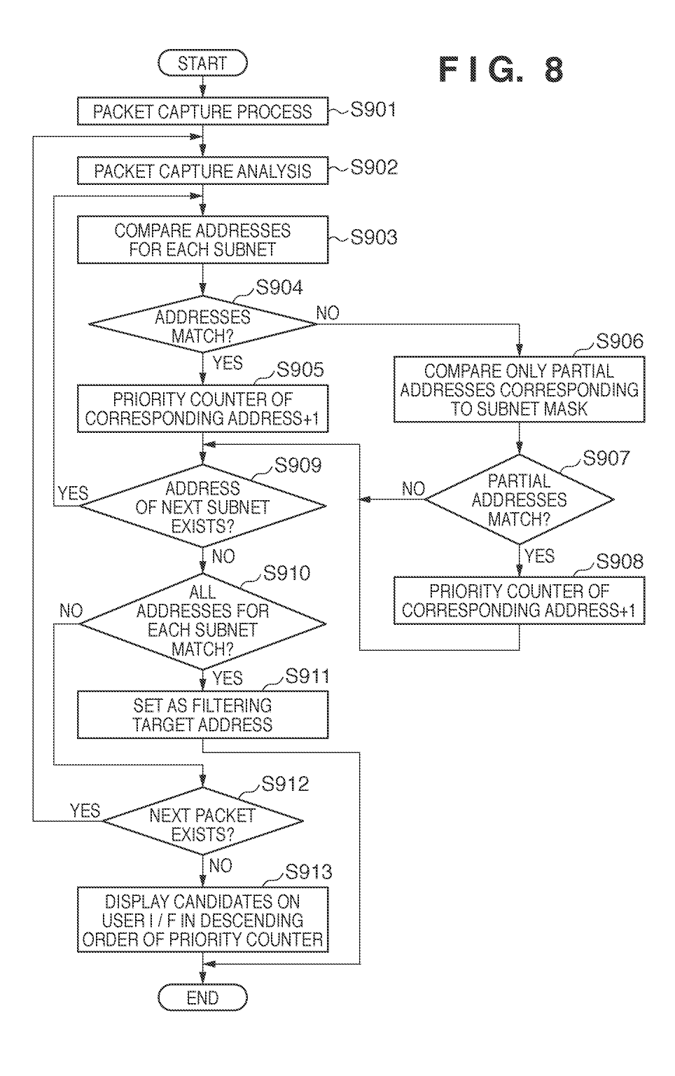

In S809, the packet capture application 305 determines whether the divided individual addresses all completely match. If the divided individual addresses all completely match, the processing proceeds to S810, and the packet capture application 305 sets the network address described in the filter rule as the filtering target address, and ends the processing. On the other hand, if the divided individual addresses do not all completely match, the processing proceeds to S811, and the packet capture application 305 acquires a subsequent network address held in the MFP 101 from the network setting unit 403. Here, if there is a network address to be acquired, the processing returns to S801. On the other hand, if there is not, the next processing is performed. The next processing will be discussed below using FIG. 8.

Subsequently, the processing procedure of the next portion of processing after FIG. 7 will be described in detail with reference to FIG. 8. In S901, the packet capture application 305 captures network packets flowing over the LAN to which the MFP 101 is connected for a fixed period of time. In S902, the packet capture application 305 analyzes a captured packet and acquires a network address as a comparison target. In S903, the packet capture application 305 divides the acquired network address into each subnet. In S904, the packet capture application 305 determines whether the individual addresses match. If the individual addresses match, the processing proceeds to S905, and the packet capture application 305 increments the priority counter of this network address. A network address that in the end has a priority counter with a large value is treated as a high priority address.

On the other hand, if the individual addresses do not match at S904, the processing proceeds to S906, and the packet capture application 305 firstly refers to the subnet mask of the MFP 101. Subsequently, in S907, the packet capture application 305 determines whether the partial addresses assigned as subnets of the individual addresses match. If the partial addresses match, the processing proceeds to S908, and the packet capture application 305 increments the priority counter for this network address, and proceeds to S909. On the other hand, if the partial addresses do not match, the processing proceeds to S909.

In S909, the packet capture application 305 determines whether there is an address of a subsequent subnet. If there is an address of a subsequent subnet, the processing returns to S903. On the other hand, if there is not an address of a subsequent subnet, the packet capture application 305 ends the process of comparing the network address described in the filter rule with network addresses acquired from packets, and proceeds to S910.

In S910, the packet capture application 305 determines whether the divided individual addresses all completely match. If the divided individual addresses all completely match, the processing proceeds to S911, and the packet capture application 305 sets the network address described in the filter rule as the filtering target address, and ends the processing. If the divided individual addresses do not all completely match, the processing proceeds to S912, and the packet capture application 305 checks whether there is a packet to be analyzed. If there is, the processing returns to S902.

On the other hand, if there is not, the processing proceeds to S913, and the packet capture application 305 displays the processed network addresses on a user interface in order of priority. These priorities are assumed to higher the larger the value of the priority counter assigned for the each of the network addresses. In the case where a plurality of candidates have the same priority, the packet capture application 305 determines whether the network address candidates were generated from the network setting unit 403 of the MFP 101 or from a packet captured during the fixed period of time. In this case, processing is performed with network address candidates generated from the network setting unit 403 of the MFP 101 given higher priority, and network address candidates generated from packets captured during the fixed period of time given lower priority. In relation to the two candidate generation conditions, network address candidates with the same priority that were generated under the same conditions are displayed in the order in which they were generated.

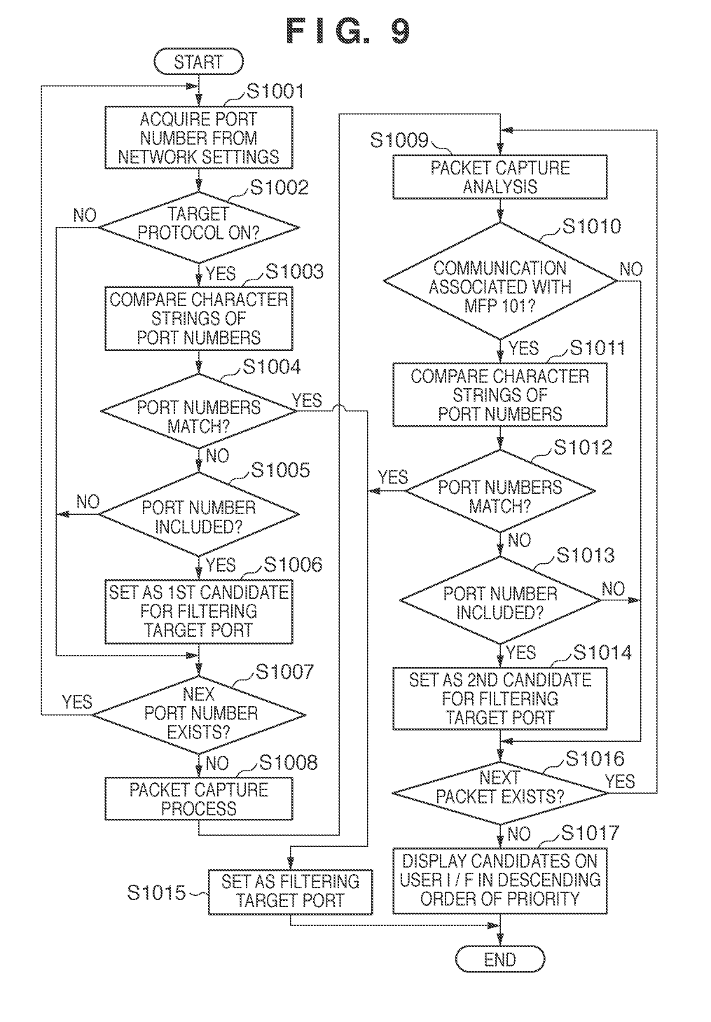

Next, the processing procedure of S606 in FIG. 5 will be described in detail with reference to FIG. 9. In S1001, the packet capture application 305 acquires the number of a port supported by the MFP 101 from the network setting unit 403 as a comparison target. In S1002, the packet capture application 305 determines whether the network protocol of the port number acquired at S1001 is a setting that is currently active on the MFP 101. If an inactive setting, the processing proceeds to S1007.

On the other hand, if an active setting, the processing proceeds to S1003, and the packet capture application 305 compares the acquired port number with the port number described in the filter rule. The packet capture application 305 thereby verifies the necessity for changing the filter rule. Here, the port number acquired from the network setting unit 403 is a number uniquely defined in the MFP 101. In S1004, the packet capture application 305 determines whether the port numbers match, in accordance with the comparison result. If the port numbers match, the processing proceeds to S1015.

On the other hand, if the port numbers do not match, the processing proceeds to S1005, and the packet capture application 305 determines whether there is a character string that includes the port number described in the filter rule. If there is not a character string that includes the port number, the processing proceeds to S1007. On the other hand, if there is a character string that includes the port number, the processing proceeds to S1006, and the packet capture application 305 sets that port as a first candidate for filtering target port.

Next, in S1007, the packet capture application 305 determines whether there is a port number to be acquired from the network setting unit 403. If there is, the processing returns to S1001. On the other hand, if there is not, the processing proceeds to S1008, and the packet capture application 305 captures network packets flowing over the LAN to which the MFP 101 is connected for a fixed period of time. Subsequently, in S1009, the packet capture application 305 analyzes a captured packet and distinguishes the port number. Then, in S1010, the packet capture application 305 determines whether the analyzed packet is associated with communication with the MFP 101. This is determined using MAC addresses or IP addresses. At this time, transmission packets to a broadcast address or a multicast address are also included as communication associated with the MFP 101. If not communication associated with the MFP 101, the processing proceeds to S1016.

On the other hand, if communication associated with the MFP 101, the processing proceeds to S1011, and the packet capture application 305 compares the port number acquired from the packet with the port number described in the filter rule. Subsequently, in S1012, the packet capture application 305 determines whether the port numbers match, in accordance with the comparison result. If the port numbers match, the processing proceeds to S1015. On the other hand, if the port numbers do not match, the processing proceeds to S1013, and the packet capture application 305 determines whether there is a character string that includes the port number described in the filter rule. If there is not a character string that includes the port number, the processing proceeds to S1016.

On the other hand, if there is a character string that includes the port number, the packet capture application 305, in S1014, sets that port as a second candidate for filtering target port. With the candidates for filtering target port, since there is a greater possibility of filtering being performed with port candidates generated from the network setting unit 403, these port candidates are given higher priority, and port candidates generated as a result of capturing packets are given lower priority.

In S1015, the packet capture application 305 sets the matching port number as the filtering target port, and ends the processing. Also, in S1016, the packet capture application 305 determines whether there is a packet to be analyzed. If there is, the processing returns to S1009. If there is not, the processing proceeds to S1017, and the packet capture application 305 displays the generated port candidates on a user interface in order of priority. In the case a plurality of candidates having the same priority, the candidates are displayed in the order in which they were generated.

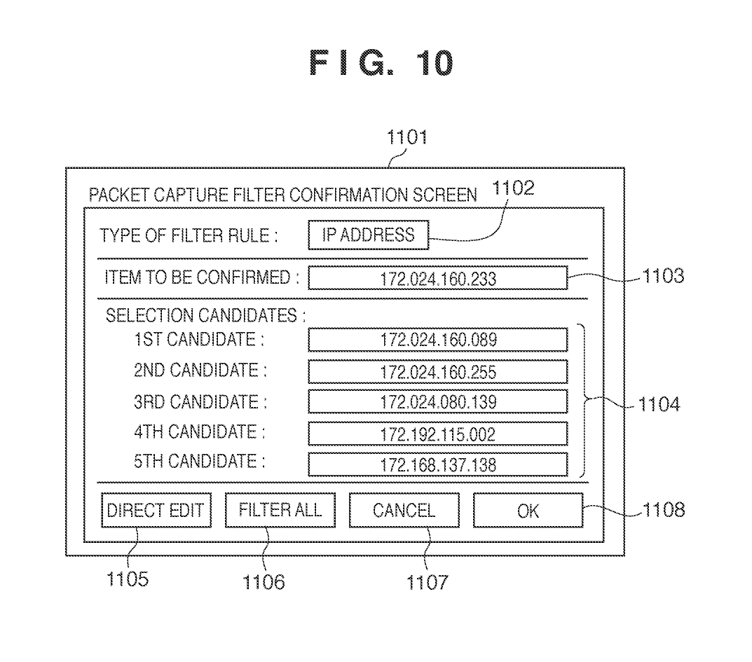

Next, an example of a user interface on which candidates generated by the packet capture application 305 are displayed in descending order of priority will be described with reference to FIG. 10. Reference numeral 1101 denotes a display screen on which candidates generated by the packet capture application 305 are displayed in descending order of priority. Reference numeral 1102 denotes the type of filter rule checked by the packet capture application 305. Here, display is performed assuming that the checked filter rule type is IP address.

Reference numeral 1103 denotes the content of the filter rule for the checked filter rule type 1102. Here, a state is shown where an IP address “172.024.160.233” set as a filter rule is displayed for confirmation by the service person, having been determined by the packet capture application 305 to be unsuitable as a filter rule. Reference numeral 1104 denotes modification candidates for the filter rule determined to be unsuitable. The filter rule modification candidates 1104 are displayed in descending order of priority, based on the candidate generation process by the packet capture application 305.

Reference numeral 1105 is a Direct Edit button. The Direct Edit button 1105 is pressed if the IP address to be set as a filter rule is neither the filter rule 1103 nor displayed among the filter rule modification candidates 1104. The packet capture application 305 thereby directly edits the IP address in accordance with a user input. Reference numeral 1106 is a Filter All execution button. The content thereof will be discussed in detail in a Second Embodiment. Reference numeral 1107 is the Cancel button of the display screen 1101. The Cancel button 1107 is used in the case of interrupting the filtering process of the packet capture application 305. Reference numeral 1108 is the OK button of the display screen 1101. The filter rule modification candidates 1104 are selectable, and the filter rule is finalized by pressing the OK button 1108 either when a filter rule modification candidate 1104 is selected, or by directly inputting an IP address using the Direct Edit button 1105, or without making any changes. Then, the packet capture application 305 captures packet data flowing through the network in accordance with the finalized filter rule. Specifically, when the first candidate “172.024.160.089” is selected on the display screen 1101, for example, the packet capture application 305 captures only packet data having this IP address as its transmission destination or transmission source. Note that a plurality of these candidates may be selected.

As described above, the MFP 101 serving as an information processing apparatus according to the present embodiment evaluates the necessity for changing storage conditions defined in filter setting data created by the developer or the like, and, when there is a rule that needs to be changed, displays a plurality of change candidates and causes a service person to select from these change candidates. Further, the MFP 101 generates a filter based on an input from the service person and appropriate filter setting data, and captures packet data using the generated filter. In the present embodiment, log data for analyzing a failure can thereby be efficiently acquired in the case where a failure occurs in a marketplace. Also, according to the present embodiment, effective filter settings can be inferred and selected even in an environment where the network settings of an apparatus operating in a marketplace change dynamically, enabling packets effective at the time that a failure occurs to be captured. Therefore, in the present embodiment, cost in terms of time and delays in responding to a marketplace failure due to the service person again going to the location of the failure and repeating the process of configuring filter settings and acquiring log data can be reduced.

### Second Embodiment

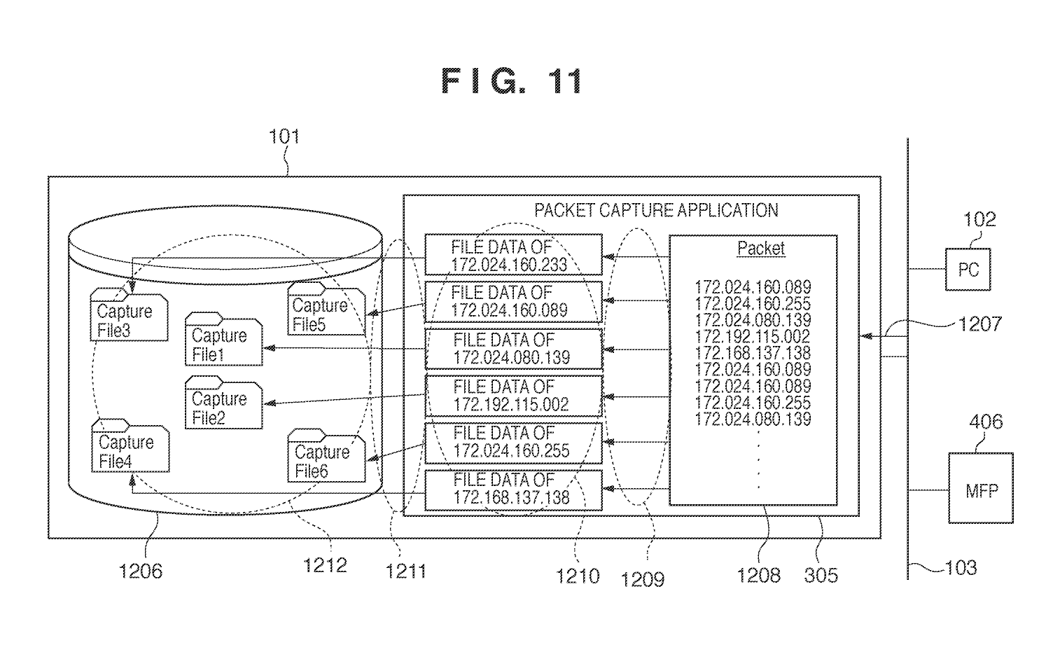

Next, a Second Embodiment will be described with reference to FIG. 11. The present embodiment, different from the First Embodiment, is effective in the case where a service person who responds in the field does not recognize the filter rules for performing packet capture, and in the case where it is not possible to gather detailed information from the development side that created the filter rules. Example execution of the filtering process of the packet capture application 305 in the case where the Filter All execution button 1106 in FIG. 10 is pressed will be described with reference to FIG. 11.

Reference numeral 1206 denotes a nonvolatile memory used in the MFP 101, such as a magnetic disk. An arrow 1207 denotes the flow of data when the MFP 101 captures network packet data flowing over the LAN 103. When the Filter All execution button 1106 in FIG. 10 is pressed, the packet capture application 305 captures packet data flowing over the LAN 103 for a fixed period of time.

Reference numeral 1208 denotes packet data captured by the packet capture application 305. Arrows 1209 denote the flow of packet data when the packet capture application 305 has filtered the packet data 1208. The packet capture application 305 performs the filtering process separately on each of the captured packet data 1208 in accordance with the filter rule 1103 and the filter rule modification candidates 1104 displayed on the display screen 1101. According to the example of the filter rule 1103 and the filter rule modification candidates 1104, the packet capture application 305 filters the captured packet data 1208 for each of six IP addresses.

Reference numeral 1210 denotes filter packet data generated as a result of the packet capture application 305 filtering the captured packet data separately for each filter rule. Arrows 1211 indicate the flow of filtered packet data 1210 generated by the packet capture application 305. The packet capture application 305 stores the filtered packet data 1210 generated by filtering the captured packet data separately for each filter rule in the nonvolatile memory 1206. Reference numeral 1212 denotes a state where filtered packet data generated by the packet capture application 305 has been stored separately as files in the nonvolatile memory 1206. The service person is thereby able to capture all packet data corresponding to the candidates displayed on the display screen 1101, by pressing the Filter All execution button 1106 even if he or she does not recognize detailed information about packets that the development side wants to capture. According to the MFP 101 of the present embodiment, necessary packets can thereby be captured even if the service person does not possess the necessary information.

### Other Embodiments

Aspects of the present invention can also be realized by a computer of a system or apparatus (or devices such as a CPU or MPU) that reads out and executes a program recorded on a memory apparatus to perform the functions of the above-described embodiment(s), and by a method, the steps of which are performed by a computer of a system or apparatus by, for example, reading out and executing a program recorded on a memory apparatus to perform the functions of the above-described embodiment(s). For this purpose, the program is provided to the computer for example via a network or from a recording medium of various types serving as the memory apparatus (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-142710, filed on Jun. 15, 2009, which is hereby incorporated by reference herein in its entirety.

1. An information processing apparatus connected to an external apparatus via a network, comprising:
reception means for receiving filter setting data in which a storage condition is defined, the storage condition being a condition for storing necessary packet data as log data from packet data flowing through the network;
determination means for determining whether or not the storage condition defined in the received filter setting data needs to be changed;
display control means for displaying, on a display unit, a display screen including a plurality of change candidates relating to the storage condition, when it is determined that the storage condition needs to be changed;
change means for changing the storage condition defined in the filter setting data in accordance with information input by an operator via the display screen;
generation means for generating a filter in accordance with the filter setting data; and
capture means for capturing the packet data using the generated filter.

2. The information processing apparatus according to claim 1, wherein the display control means further displays, on the display unit, priorities of the plurality of change candidates.

3. The information processing apparatus according to claim 1, wherein the determination means determines whether or not the storage condition needs to be changed, by comparing the storage condition in the filter setting data with network setting information of the information processing apparatus held by the information processing apparatus.

4. The information processing apparatus according to claim 1, wherein the determination means determines whether or not the storage condition needs to be changed, by comparing the storage condition in the filter setting data with information relating to packet data transmitted or received by the information processing apparatus with respect to the external apparatus.

5. The information processing apparatus according to claim 1, wherein the storage condition includes at least one of an IP address indicating a transmission source or a transmission destination of the packet data, a MAC address indicating the transmission source or the transmission destination of the packet data, a port number indicating the transmission source or the transmission destination of the packet data, and a network protocol name.

6. The information processing apparatus according to claim 5, wherein the determination means determines whether or not the storage condition needs to be changed, by comparing a value of at least one of the IP address, the MAC address and the port number with a value of a comparison target, and determines whether or not the storage condition needs to be changed, by comparing a character string of the network protocol name with a character string of a comparison target.

7. A control method of an information processing apparatus connected to an external apparatus via a network, comprising:
receiving, in reception means, filter setting data in which a storage condition is defined, the storage condition being a condition for storing necessary packet data as log data from packet data flowing through the network;
determining, in determination means, whether or not the storage condition defined in the received filter setting data needs to be changed;
displaying, in display control means, a display screen including a plurality of change candidates relating to the storage condition on a display unit, when it is determined that the storage condition needs to be changed;
changing, in change means, the storage condition defined in the filter setting data in accordance with information input by an operator via the display screen;
generating, in generation means, a filter in accordance with the filter setting data; and
capturing, in capture means, the packet data using the generated filter.

8. A computer-readable storage medium storing a computer program for causing a computer to execute the control method of an information processing apparatus according to claim 7.
